(19) United States
(12) Patent Application Publication
(10) Pub. No.: US 2024/0029941 A1
(43) Pub. Date: Jan. 25, 2024

(54) COIL COMPONENT

(71) Applicant: SAMSUNG ELECTRO-MECHANICS CO., LTD., Suwon-si (KR)

(72) Inventors: Dong Hwan LEE, Suwon-si (KR); Chan YOON, Suwon-si (KR); Dong Jin LEE, Suwon-si (KR); Tae Hyun KIM, Suwon-si (KR); Byeong Cheol MOON, Suwon-si (KR); Boum Seock KIM, Suwon-si (KR)

(73) Assignee: SAMSUNG ELECTRO-MECHANICS CO., LTD., Suwon-si (KR)

(21) Appl. No.: 18/102,911

(22) Filed: Jan. 30, 2023

(30) Foreign Application Priority Data
Jul. 20, 2022 (KR) 10-2022-0089665

(51) Int. Cl. H01F 27/28; H01F 27/29

(52) U.S. Cl. CPC H01F 27/2804; H01F 27/292

(57) ABSTRACT

A coil component includes a body, a first coil disposed in the body and including a first winding portion having a turns number less than one turn, a second coil disposed in the body and including a second winding portion having a turns number less than one turn, a first external electrode and a second external electrode, respectively connected to one end and the other end of the first coil, and a third external electrode and a fourth external electrode, respectively connected to one end and the other end of the second coil. A portion of the first winding portion is disposed on an internal side of the second winding portion, and a portion of the second winding portion is disposed on an internal side of the first winding portion.

### CROSS-REFERENCE TO RELATED APPLICATION(S)

This application claims benefit of priority to Korean Patent Application No. 10-2022-0089665 filed on Jul. 20, 2022 in the Korean Intellectual Property Office, the disclosure of which is incorporated herein by reference in its entirety.

### TECHNICAL FIELD

The present disclosure relates to a coil component having an inductor array structure.

### BACKGROUND

With the miniaturization and slimming of electronic devices such as digital TVs, mobile phones, laptop PCs, and the like, there has been increasing demand for the miniaturization and thinning of coil components used in such electronic devices. To satisfy such demand, research and development of various winding-type or thin film-type coil components have been actively conducted.

A main issue depending on the miniaturization and thinning of the coil component is to maintain characteristics of an existing coil component in spite of the miniaturization and thinning thereof. To satisfy such demand, a ratio of a magnetic material should be increased in a core in which the magnetic material is filled. However, there may be a limitation in increasing the ratio due to a change in strength of an inductor body of an inductor, frequency characteristics depending on insulation properties of the inductor body, and the like.

There is increasing demand for an array-type component having an advantage of reducing a mounting area of a coil component. An array-type coil component may have a noncoupled or coupled inductor type or a mixture of the noncoupled and coupled types, according to a coupling coefficient or mutual inductance between a plurality of coil portions.

### SUMMARY

An aspect of the present disclosure is to sufficiently secure a coupling coefficient between coils in an inductor array-type coil component having relatively low inductance.

According to an aspect of the present disclosure, a coil component includes a body, a first coil disposed in the body and including a first winding portion having a turns number less than one turn, a second coil disposed in the body and including a second winding portion having a turns number less than one turn, a first external electrode and a second external electrode, respectively connected to one end and the other end of the first coil, and a third external electrode and a fourth external electrode, respectively connected to one end and the other end of the second coil. A portion of the first winding portion is disposed on an internal side of the second winding portion, and a portion of the second winding portion is disposed on an internal side of the first winding portion.

The first and second winding portions may share a core with each other.

Each of the first and second winding portions may have a ¾ turn.

The coil component may further include a support member disposed in the body. The first and second winding portions may be disposed on one surface of the support member.

The first and second winding portions may be disposed on the same level with respect to the one surface of the support member.

One end of the first coil may be as one end of the first winding portion, and one end of the second coil may be as one end of the second winding portion.

The other end of the first coil and the other end of the second coil may be disposed on the other surface opposing the one surface of the support member.

The other end of the first coil and the other end of the second coil may be disposed on the same level with respect to the other surface of the support member.

In the first coil, an additional turn may not be formed by the other end of the first coil other than the first winding portion.

In the second coil, an additional turn may not be formed by the other end of the second coil other than the second winding portion.

The body may have a first surface and a second surface opposing each other in a first direction, and the one end and the other end of the first coil may be led out to the first surface and the one end and the other end of the second coil may be led out to the second surface.

The first external electrode may be disposed in a position facing the fourth external electrode, and the second external electrode may be disposed in a position facing the third external electrode.

The body may have a first surface and a second surface opposing each other in a first direction and a third surface and a fourth surface opposing each other in a second direction. The one end of the first coil may be led out to the first surface. The one end of the second coil may be led out to the second surface. The other end of the first coil may be led out to the third surface. The other end of the second coil may be led out to the fourth surface.

The first and second coils may not be connected to each other in the coil component.

According to an aspect of the present disclosure, a coil component includes: a body, a support member disposed within the body and having one surface and the other surface opposing each other, a first coil including a first winding portion disposed on one surface of the support member, a second coil including a second winding portion disposed on one surface of the support member, a first external electrode and a second external electrode, respectively connected to one end and the other end of the first coil, and a third external electrode and a fourth external electrode, respectively connected to one end and the other end of the second coil. The one end of the first coil is formed as one end of the first winding portion, and the one end of the second coil is formed as one end of the second winding portion. The other end of the first coil and the other end of the second coil are disposed on the other surface of the support member. In the first coil, an additional turn is not formed by the other end of the first coil other than the first winding portion. In the second coil, an additional turn is not formed by the other end of the second coil other than the second winding portion.

Each of the first and second winding portion may have a turns number less than one turn.

A portion of the first winding portion may be disposed on an internal side of the second winding portion, and a portion of the second winding portion may be disposed on an internal side of the first winding portion.

According to an aspect of the present disclosure, a coil component includes: a body including a first surface and a second surface opposing each other in a first direction and a third surface and a fourth surface opposing each other in a second direction; a first coil and a second coil disposed within the body and sharing a core with each other; a first external electrode and a second external electrode disposed on the body and connected to the first coil; and a third external electrode and a fourth external electrode disposed on the body and connected to the second coil. Among winding portions of the first coil and the second coil, only the winding portion of the first coil is disposed between the core and the first surface, and among the winding portions of the first coil and the second coil, only the winding portion of the second coil is disposed between the core and the second surface.

The winding portion of the first coil and the winding portion of the second coil may be disposed between the core and the third surface and between the core and the fourth surface.

The coil component may further include a support member disposed in the body. The winding portion of the first coil and the winding portion of the second coil may be disposed on one side of the support member.

The winding portion of the first coil and the winding portion of the second coil may be disposed on the same level with respect to one surface of the support member.

The first and second external electrodes may be closer to the first surface than the second surface, and the third and fourth external electrodes may be closer to the second surface than the first surface.

### BRIEF DESCRIPTION OF DRAWINGS

The above and other aspects, features, and advantages of the present disclosure will be more clearly understood from the following detailed description, taken in conjunction with the accompanying drawings.

FIG. 1 is a schematic perspective view illustrating a coil component according to an exemplary embodiment of the present disclosure.

FIGS. 2 and 3 are plan views illustrating main elements in the coil component of FIG. 1, when viewed from above.

FIG. 4 is a plan view illustrating a coil component according to a modified example and illustrating main elements such as first and second coils, an external electrode, and the like, when viewed from above.

### DETAILED DESCRIPTION

Hereinafter, embodiments in the present disclosure will be described as follows with reference to the attached drawings. The present disclosure may, however, be exemplified in many different forms and should not be construed as being limited to the specific embodiments set forth herein. Rather, these embodiments are provided so that this disclosure will be thorough and complete, and will fully convey the scope of the disclosure to those skilled in the art. Accordingly, shapes and sizes of the elements in the drawings can be exaggerated for clear description. Also, elements having the same function within the scope of the same concept represented in the drawing of each exemplary embodiment will be described using the same reference numeral.

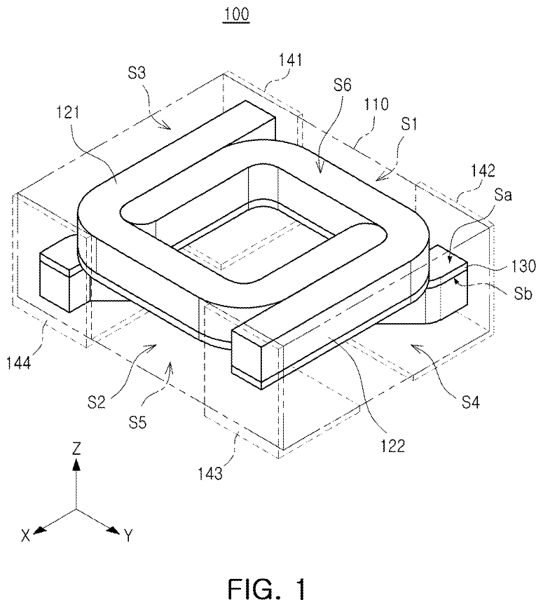

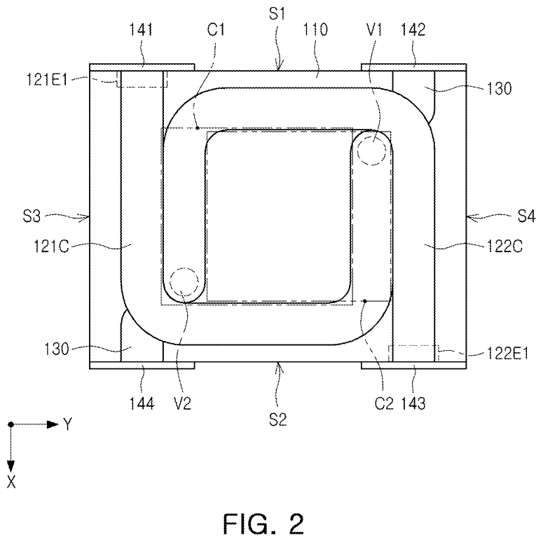

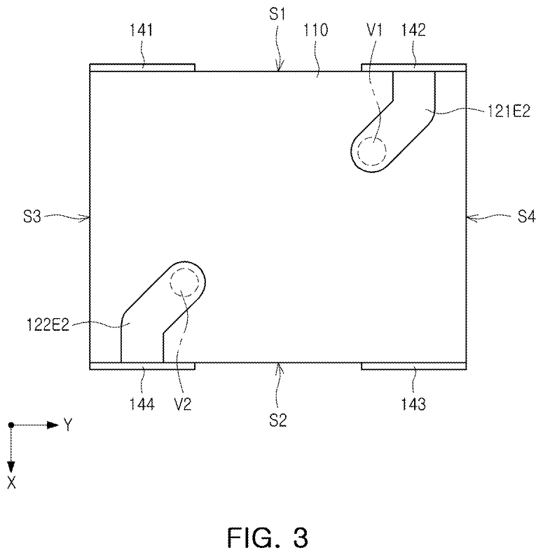

FIG. 1 is a schematic perspective view illustrating a coil component according to an exemplary embodiment. FIGS. 2 and 3 are plan views illustrating main elements in the coil component of FIG. 1, when viewed from above. Referring to FIGS. 1 to 3, a coil component 100 according to an exemplary embodiment may include a body 110, a first coil 121, a second coil 122, and first to fourth external electrodes 141 to 144. Each of the first and second coils 121 and 122 may have a turns number less than one turn. A portion of a first winding portion 121C of the first coil 121 may be disposed on an internal side of the second winding portion 122C of the second coil 122, and a portion of a second winding portion 122C may be disposed on an internal side of the first winding portion 121C. The internal sides of the first and second winding portions 121C and 122C may be defined in a direction toward a center of a core from the first and second winding portions 121C and 122C, respectively. As in the present embodiment, a portion of the first winding portion 121C of the first coil 121 is disposed on the internal side of the second winding portion 122C of the second coil 122 and a portion of the second winding portion 122C may be disposed on the internal side of the first winding portion 121C, so that a coupling coefficient of the first and second coil components 121 and 122 may be sufficiently secured in the inductor array-type coil component 100 having low inductance, which will be described later in detail. Hereinafter, main elements constituting the coil component 100 according to the present embodiment will be described.

The body 101 may include the first and second coils 121 and 122, and the like, disposed therein and may form an overall exterior of the coil component 100. In this case, the body 110 may have a first surface S1 and a second surface S2 disposed to be perpendicular to a first direction (an X-direction) while opposing each other, a third surface S3 and a fourth surface S4 disposed to be perpendicular to a second direction (a Y-direction) while opposing each other, and a fifth surface S5 and a fifth surface S6 disposed to be perpendicular to a third direction (a Z-direction) while opposing each other. The first direction (the X-direction), the second direction (the Y-direction), and the third direction (the Z-direction) may be perpendicular to each other. The third direction (the Z-direction) may correspond to a thickness direction of the body 110, the support member 130, and the like.

The body 101 may include an insulating resin and a magnetic material. For example, the body 101 may be formed by laminating one or more magnetic composite sheets in which a magnetic material is dispersed in an insulating resin. The magnetic material may be, for example, a ferrite powder particle or a magnetic metal powder particle. Examples of the ferrite powder particle may include at least one or more of spinel type ferrites such as Mg—Zn-based ferrite, Mn—Zn-based ferrite, Mn—Mg-based ferrite, Cu—Zn-based ferrite, Mg—Mn—Sr-based ferrite, Ni—Zn-based ferrite, and the like, hexagonal ferrites such as Ba—Zn-based ferrite, Ba—Mg-based ferrite, Ba—Ni-based ferrite, Ba—Co-based ferrite, Ba—Ni—Co-based ferrite, and the like, garnet type ferrites such as Y-based ferrite, and the like, and Li-based ferrites. The magnetic metal powder particle may include one or more selected from the group consisting of iron (Fe), silicon (Si), chromium (Cr), cobalt (Co), molybdenum (Mo), aluminum (Al), niobium (Nb), copper (Cu), and nickel (Ni) For example, the magnetic metal powder particle may be at least one or more of a pure iron powder, a Fe—Si-based alloy powder, a Fe—Si—Al-based alloy powder, a Fe—Ni-based alloy powder, a Fe—Ni—Mo-based alloy powder, a Fe—Ni—Mo—Cu-based alloy powder, a Fe—Co-based alloy powder, a Fe—Ni—Co-based alloy powder, a Fe—Cr-based alloy powder, a Fe—Cr—Si-based alloy powder, a Fe—Si—Cu—Nb-based alloy powder, a Fe—Ni—Cr-based alloy powder, and a Fe—Cr—Al-based alloy powder. The metallic magnetic material may be amorphous or crystalline. For example, the magnetic metal powder particle may be a Fe—Si—B—Cr-based amorphous alloy powder, but exemplary embodiments are not limited thereto. Each of the ferrite powder and the magnetic metal powder particle may have an average diameter of about 0.1 μm to 30 μm, but exemplary embodiments are not limited thereto. The body 100 may include two or more types of magnetic materials dispersed in a resin. In this case, the term “different types of magnetic material” means that the magnetic materials dispersed in the resin are distinguished from each other by average diameter, composition, crystallinity, and shape. The resin may include an epoxy, a polyimide, a liquid crystal polymer, or the like, in a single form or in combined forms, but exemplary embodiments are not limited thereto.

With respect to an example of the manufacturing method, the body 101 may be formed by a lamination method. For example, a plurality of unit laminates for manufacturing the body 101 may be prepared and laminated on upper and lower portions of the coil portion 103. The unit laminate is prepared by mixing magnetic particles such as a metal and an organic material such as a thermosetting resin, a binder, and a solvent to prepare a slurry, applying the slurry to a carrier film using a doctor blading method to have a thickness of several tens of micrometers (μm), drying the slurry, and manufacturing the unit laminate in the form of a sheet. Accordingly, the unit laminate may be manufactured to have a form in which magnetic particles are dispersed in a thermosetting resin such as an epoxy resin, a polyimide, or the like.

The first coil 121 may be disposed in the body 110. In the present embodiment, the first coil 121 may include a first winding portion 121C having a turns number less than one turn (for example, about ¾ turn), and thus, the coil component 100 may be used as a low-inductance element. One end 121E1 and the other end 121E2 of the first coil 121 may be connected to the first and second external electrodes 141 and 142, respectively, to form a single coil structure. In this case, the one end 121E1 of the first coil 121 may be formed as one end of the first winding portion 121C. Similarly, the second coil 122 may be disposed in the body 110 and may include a second winding 122C having a turns number less one turn (for example, about ¾ turn). One end 122E1 and the other end 122E2 of the second coil 122 may be connected to the third and fourth external electrodes 143 and 144, respectively, to form a single coil structure. In this case, the one end 122E1 of the second coil 122 may be formed as one end of the second winding portion 122C. The first and second coils 121 and 122 may be implemented in the form of an inductor array and may not be electrically connected to each other in the coil component 100. Accordingly, the first and second coils 121 and 122 may be magnetically coupled only in the coil component 100. Winding axes of the first and second winding portions 121C and 122C may be parallel to the third direction (the Z direction), as illustrated in the drawings.

As a structure for achieve relatively low inductance, the first and second winding portions 121C and 122C should have a turns number less than one turn, and a portion of the first winding portion 121C of the first coil 121 should disposed in the second winding portion 122C of the second coil 122 and a portion of the second winding portion 122C does not have to be disposed in the first winding portion 121C. As will be described later, the first and second coils 121 and 122 may be implemented as a single-layer structure, in which the winding portions 121C and 122C are disposed only on one side of the support member 130, to have low inductance. Such a structure having a turns number less than one turn and such a single-layer structure may be independently employed or may be simultaneously employed, as illustrated in FIGS. 1 to 3.

As described above, a portion of the first winding portion 121C may be disposed in the second winding portion 122C, and a portion of the second winding portion 122C may be disposed in the first winding portion 121C. When the coil component 100 has relatively low inductance, as lengths of the first and second coils 121 and 122 are reduced, a region in which magnetic coupling occurs in the first and second coils 121 and 122 may also be reduced. Accordingly, the coupling coefficient of the first and second coils 121 and 122 may be reduced. As in the present embodiment, a portion of the first winding portion 121C may be disposed in the second winding portion 122C, and a portion of the second winding portion 122C may be disposed in the first winding portion 121C. Accordingly, an area in which the first winding portion 121C and the second winding portion 122C are disposed side by side may be sufficiently secured to lead to an improvement in the coupling coefficient of the first and second coils 121 and 122. In this case, a relatively improved binding coefficient may have an absolute value of about 0.4 or more, in more detail, about 0.5 or more. As described above, as the first and second winding portions 121C and 122C are disposed to be adjacent to each other, the first and second winding portions 121C and 122C may share cores C1 and C2 with each other. For example, the core C1 of the first winding portion 121C and the core C2 of the second winding portion 122C may have an overlapping region in the third direction (the Z-direction).

The first and second coils 121 and 122 may be a plating pattern formed using a plating process used in the art, for example, pattern plating, anisotropic plating, isotropic plating, or the like, and may be formed as a multilayer structure using a plurality of processes, among the above-mentioned processes. A material forming the first and second coils 121 and 122 may include a conductive material such as copper (Cu), aluminum (Al), silver (Ag), tin (Sn), gold (Au), nickel (Ni), lead (Pb), titanium (Ti), chromium (Cr), alloys thereof, but exemplary embodiments are not limited thereto.

The support member 130 may support the first and second coils 121 and 122 and may be formed as, for example, a polypropylene glycol (PPG) substrate, a ferrite substrate, or a metal-based soft magnetic substrate. As illustrated in the drawings, a through-hole may be formed to penetrate through a portion of the support member 130, and a material forming the body 110 may fill the through-hole. Accordingly, cores C1 and C2 may be formed in the first and second coils 121 and 122, respectively.

In the present embodiment, the first and second winding portions 121C and 122C may be disposed on one surface Sa (an upper surface based on the drawing) of the support member 130. In this case, the first and second winding portions 121C and 122C may be disposed on the same level with respect to the one surface Sa of the support member 130. As described above, the one end 121E1 of the first coil 121 may be formed as one end of the first winding portion 121C, and the one end 122E1 of the second coil 122 may be formed as an end of the second winding portion 122C. In addition, the other end 121E2 of the first coil 121 and the other end 122E2 of the second coil 122 may be disposed on the other surface Sb opposing the one surface Sa in the support member 130 (based on the drawing). In this case, the other end 121E2 of the first coil 121 and the other end 122E2 of the second coil 122 may be disposed on the same level with respect to the other surface Sb of the support member 130. In the first coil 121, the first winding portion 121C and the other end 121E2 may be connected to each other by a first conductive via V1, and the first conductive via V1 may penetrate through the support member 130. In the second coil 122, the second winding portion 122C and the other end 122E2 may be connected to each other by a second conductive via V2, and the second conductive via V2 may penetrate through the support member 130. In this case, the first and second coils 121 and 122 may not separately include a pad portion having a relatively large width in a region connected to the first and second conductive vias V1 and V2. Due to such a shape, the first and second coils 121 and 122 are disposed to be adjacent to each other to sufficiently secure a magnetically closely coupled region.

In the present embodiment, in the first coil 121, an additional turn may not be formed by the other end 121E2 of the first coil 121 other than the first winding portion 121C. This means that, when viewed from above in the third direction (the Z-direction), the first coil 121 does not have a region, forming a turn of the coil, other than the first winding portion 121C. To this end, the other end 121E2 of the first coil 121 may extend in a direction, other than a direction in which the turn proceeds in the first winding portion 121C, to be connected to the second external electrode 142. Similarly, in the second coil 122, an additional turn may not be formed by the other end 122E2 of the second coil 122 other than the second winding portion 122C. This means that, when viewed from above in the third direction (the Z-direction), the second coil 122 does not have a region, forming a turn of the coil, other than the second winding portion 122C. In order for this, the other end 122E2 of the second coil 122 may extend in a direction, other than a direction in which the turn proceeds in the second winding portion 122C, to be connected to the fourth external electrode 144. As described above, the first and second coils 121 and 122 may have a single-layer coil structure in which a coil structure is formed only on a side of the one surface Sa of the support member 130 such that the coil component 100 has relatively low inductance.

As illustrated in the drawings, the one end 121E1 and the other end 121E2 of the first coil 121 may be led out to the first surface S1 of the body 110, and may be connected to the first external electrode 141 and the second external electrode 142, respectively. In addition, the one end 122E1 and the other end 122E2 of the second coil 122 may be led out to the second surface S2 of the body 110, and may be connected to the third external electrode 143 and the fourth external electrode 144, respectively. To this end, the first external electrode 141 and the second external electrode 142 may be disposed on the first surface S1 of the body 110, and the third external electrode 143 and the fourth external electrode 144 may be disposed on the second surface S2 of the body 110. As a more detailed example, the first external electrode 141 may be disposed in a position facing the fourth external electrode 144, and the second external electrode 142 may be disposed in a position facing the third external electrode 143. That is, the first and second external electrodes 141 and 142 may be closer to the first surface S1 than the second surface S2, and the third and fourth external electrodes 143 and 144 may be closer to the second surface S2 than the first surface S1. In addition, the first to fourth external electrodes 141 to 144 may extend to the fifth surface S5 of the body 110. In this case, the fifth surface S5 of the body 110 may be provided as a mounting surface of the coil component 100. Alternatively or optionally, the first to fourth external electrodes 141 to 144 may additionally extend to the sixth surface S6 of the body 110, although not shown in the drawings.

The first to fourth external electrodes 141 to 144 may be formed using a paste including a metal having improved electrical conductivity. For example, the paste may be a conductive paste including nickel (Ni), copper (Cu), tin (Sn), silver (Ag), or alloys thereof. A plating layer may be provided to cover each of the first and second external electrodes 141 to 144. In this case, the plating layer may include at least one selected from the group consisting of nickel (Ni), copper (Cu), and tin (Sn). For example, the plating layer may include a nickel (Ni) layer and a tin (Sn) layer sequentially formed.

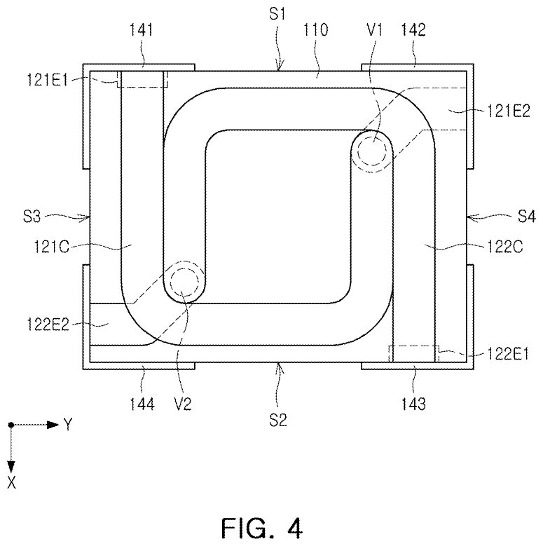

FIG. 4 is a plan view illustrating a coil component according to a modified example and illustrates main components such as first and second coils and external electrodes when viewed from above. Although a support member of the previous embodiment is omitted in FIG. 4, it is apparent that the support member 130 may be employed in the embodiment of FIG. 4. A structure changed in the modified example lies in shapes of the other ends 121E2 and 122E2 of first and second coils 121 and 122. For example, as illustrated in the drawing, the other end 121E2 of the first coil 121 may be led out to a fourth surface S4 of a body 110, and the other end 122E2 of the second coil 122 may be led out to a third surface S3 of the body 110. Accordingly, a second external electrode 142 connected to the other end 121E2 of the first coil 121 may be disposed on the first surface S1 and the fourth surface S4 of the body 110, and the fourth external electrode 144 connected to the other end 122E2 of the second coil 122 may be disposed on the second surface S2 and the third surface S3 of the body 110. In this case, the first external electrode 141 may be disposed on the first surface S1 and the third surface S3 of the body 110 and the third external electrode 143 may be disposed on the second surface S2 and the fourth surface S4 of the body 110 such that an overall shape of the coil component 100 has symmetry. In addition, the first to fourth external electrodes 141 to 144 may extend to the fifth surface S5 of the body 110. In this case, the fifth surface S5 of the body 110 may be provided as a mounting surface of the coil component 100. Alternatively or optionally, the first to fourth external electrodes 141 to 144 may additionally extend to the sixth surface S6 of the body 110, although not shown in the drawings.

As described above, a coupling structure of the inductor array proposed in the present embodiment, for example, a method of disposing the first and second coils in the coil component having relatively low inductance may be optimized to implement a coupling coefficient of sufficient size. This was confirmed through a simulation by the inventors of the present disclosure. In a coil component having a 2016 size, that is, having a length (a length in a Y-direction) of 20 μm and a width (a length in an X-direction) of 16 μm, and a thickness (a length in a Z-direction) of 10 μm, inductance was about 20 nH. Such a coil component has an array-type coil structure described with reference to FIGS. 1 to 3, and a target coupling coefficient k was −0.5. As a result of an actual simulation, a coupling coefficient k was about −0.46, which is a high level considering that the coil component has a low-level inductance structure.

As described above, a coupling coefficient between coils may be sufficiently secured even in an inductor array-type coil component having relatively low inductance.

While example embodiments have been shown and described above, it will be apparent to those skilled in the art that modifications and variations could be made without departing from the scope of the present invention as defined by the appended claims.

What is claimed is:

1. A coil component comprising:
a body;
a first coil disposed within the body and including a first winding portion having a turns number less than one turn;
a second coil disposed within the body and including a second winding portion having a turns number less than one turn;
a first external electrode and a second external electrode, respectively connected to one end and the other end of the first coil; and
a third external electrode and a fourth external electrode, respectively connected to one end and the other end of the second coil,
wherein a portion of the first winding portion is disposed on an internal side of the second winding portion, and a portion of the second winding portion is disposed on an internal side of the first winding portion.

2. The coil component of claim 1, wherein
the first and second winding portions share a core with each other.

3. The coil component of claim 1, wherein
each of the first and second winding portions has a ¾ turn.

4. The coil component of claim 1, further comprising:
a support member disposed in the body,
wherein the first and second winding portions are disposed on one surface of the support member.

5. The coil component of claim 4, wherein the first and second winding portions are disposed on the same level with respect to the one surface of the support member.

6. The coil component of claim 4, wherein one end of the first coil is as one end of the first winding portion, and one end of the second coil is as one end of the second winding portion.

7. The coil component of claim 6, wherein the other end of the first coil and the other end of the second coil are disposed on the other surface opposing the one surface of the support member.

8. The coil component of claim 7, wherein the other end of the first coil and the other end of the second coil are disposed on the same level with respect to the other surface of the support member.

9. The coil component of claim 7, wherein in the first coil, an additional turn is not formed by the other end of the first coil other than the first winding portion.

10. The coil component of claim 9, wherein in the second coil, an additional turn is not formed by the other end of the second coil other than the second winding portion.

11. The coil component of claim 7, wherein the body has a first surface and a second surface opposing each other in a first direction,
the one end and the other end of the first coil are led out to the first surface, and
the one end and the other end of the second coil are led out to the second surface.

12. The coil component of claim 11, wherein the first external electrode is disposed in a position facing the fourth external electrode, and
the second external electrode is disposed in a position facing the third external electrode.

13. The coil component of claim 7, wherein the body has a first surface and a second surface opposing each other in a first direction and a third surface and a fourth surface opposing each other in a second direction,
the one end of the first coil is led out to the first surface, and
the one end of the second coil is led out to the second surface,
the other end of the first coil is led out to the third surface, and
the other end of the second coil is led out to the fourth surface.

14. The coil component of claim 1, wherein the first and second coils are not connected to each other in the coil component.

15. A coil component comprising:
a body;
a support member disposed within the body and having one surface and the other surface opposing each other;
a first coil including a first winding portion disposed on one surface of the support member;
a second coil including a second winding portion disposed on one surface of the support member;
a first external electrode and a second external electrode, respectively connected to one end and the other end of the first coil; and
a third external electrode and a fourth external electrode, respectively connected to one end and the other end of the second coil,
wherein the one end of the first coil is as one end of the first winding portion, and the one end of the second coil is as one end of the second winding portion,
the other end of the first coil and the other end of the second coil are disposed on the other surface of the support member,
in the first coil, an additional turn is not formed by the other end of the first coil other than the first winding portion, and
in the second coil, an additional turn is not formed by the other end of the second coil other than the second winding portion.

16. The coil component of claim 15, wherein each of the first and second winding portion has a turns number less than one turn.

17. The coil component of claim 15, wherein a portion of the first winding portion is disposed on an internal side of the second winding portion, and a portion of the second winding portion is disposed on an internal side of the first winding portion.

18. A coil component comprising:
a body including a first surface and a second surface opposing each other in a first direction and a third surface and a fourth surface opposing each other in a second direction;
a first coil and a second coil disposed within the body and sharing a core with each other;
a first external electrode and a second external electrode disposed on the body and connected to the first coil; and
a third external electrode and a fourth external electrode disposed on the body and connected to the second coil,
wherein among winding portions of the first coil and the second coil, only the winding portion of the first coil is disposed between the core and the first surface, and
among the winding portions of the first coil and the second coil, only the winding portion of the second coil is disposed between the core and the second surface.

19. The coil component of claim 18, wherein
the winding portion of the first coil and the winding portion of the second coil are disposed between the core and the third surface and between the core and the fourth surface.

20. The coil component of claim 18, further comprising:
a support member disposed in the body,
wherein the winding portion of the first coil and the winding portion of the second coil are disposed on one side of the support member.

21. The coil component of claim 20, wherein the winding portion of the first coil and the winding portion of the second coil are disposed on the same level with respect to one surface of the support member.

22. The coil component of claim 18, wherein the first and second external electrodes are closer to the first surface than the second surface, and the third and fourth external electrodes are closer to the second surface than the first surface.
